(19) United States
(12) Patent Application Publication
(10) Pub. No.: US 2024/0243986 A1
(43) Pub. Date: Jul. 18, 2024

(54) MONITORING DEVICE FOR A DATA ROUTER AND METHOD FOR MONITORING A DATA ROUTER

(71) Applicant: KEECONN GMBH, Großbeeren (DE)

(72) Inventor: Jan-Rewert RULFS, Berlin (DE)

(21) Appl. No.: 18/559,733

(22) PCT Filed: May 10, 2022
(86) PCT No.: PCT/EP2022/062571

§ 371 Date: Nov. 8, 2023

(30) Foreign Application Priority Data
May 10, 2021 (DE) 10 2021 112 179.5

(51) Int. Cl. H04L 43/0817; H04L 43/16; H04L 43/50

(52) U.S. Cl. CPC H04L 43/0817; H04L 43/16; H04L 43/50

(57) ABSTRACT

The invention relates to a system comprising a data router and a monitoring device connected to or integrated with the data router. The monitoring device is configured to monitor a power consumption of the data router and to trigger a restart or reset of the data router depending on its power consumption.

The invention relates to a system comprising a data router and a monitoring device connected to or integrated with the data router. The invention also relates to a monitoring device for a data router and a method for monitoring a data router.

Data routers—or routers for short—have the task of forwarding data packets between several data processing devices, e.g. computers or embedded systems, in a data network.

Data routers are used, for example, to connect local data processing devices to the Internet.

Data routers can be designed as cellular routers to relay data packets over the cellular network. This is particularly useful where no wired data network is available for connecting a data processing device.

Routers make their forwarding decisions based on information from network layer 3 (for the IP protocol, this is the network portion in the IP address). Many routers also translate between private and public IP addresses (Network Address Translation (NAT) or Port Address Translation (PAT)) or map firewall functions using a set of rules.

Areas of application for routers include transformer stations and charging stations that are regularly connected to the Internet. In the special case of transformer stations, these are often located far away from towns, e.g. near solar fields. Routers typically have to be restarted in longer periods of time because they have “hung up”, for example. Unfavorable events can in fact cause routers to “crash”, which is also known as “freezing”. In this case, the data connection established via the router is permanently interrupted.

In order to restore the data connection, the manufacturer often recommends resetting the router.

It is known to restart routers automatically when a monitoring unit—e.g. in the form of software—detects that a router no longer has a connection to the Internet. To do this, the monitoring unit must monitor the data traffic that passes through the router. Products already exist which also force a reset of the router (e.g. “resetplug.com”). To do this, these products connect to the router as a WiFi client (WLAN client), which limits their use to WiFi-capable routers. Furthermore, such a concept represents a potential security vulnerability.

Because the latter is unsatisfactory, there is a need for alternative means that can cause the router to restart automatically. A simple solution is to restart the router at regular predefined intervals—according to the principle of a timer. If the intervals are too long, the router may still not be able to provide an Internet connection for a significant period of time. Too short intervals for restarting the router have the disadvantage that the router has to be restarted too often, which leads to unnecessary losses of the data connection.

According to the invention, it is proposed to provide a monitoring device that monitors the energy or power consumption of the data router and triggers the restart of the data router depending on its energy or power consumption. The monitoring device according to the invention detects the crash or freezing of the data router and independently initiates a reset or restart of the data router.

The solution according to the invention includes the realization that the power consumption of the data router depends on whether the data router is sending or receiving data packets. If data packets are actually transmitted, the power consumption is higher than at times when no data is transmitted. Typically, a data router repeatedly transmits data packets at regular short intervals of a few seconds or minutes in order to maintain or establish contact with a base station (in the case of a cellular router) or with the next Internet node. As a result, the power consumption of a functioning data router fluctuates over an observation period of a few minutes. If, on the other hand, the power consumption remains approximately constant—especially constantly low—this is an indication that the data router is no longer operational and must be restarted. Accordingly, a monitoring device according to the invention can be designed in such a way that it causes a restart of the data router if its power consumption remains constant, in particular constantly low, over an observation period of a few minutes and corresponds, for example, to a previously recorded average value for the power consumption of the data router in the idle state—i.e. without an active data connection.

The same applies to the energy consumption of the data router within a certain period of time. The energy consumed by the data router within a period of time represents the average power consumption of the data router during this period.

Mobile routers typically need a minimum power to establish a data connection to the next base station, which depends, among other things, on the distance between the router and the base station. A data router that does not have a connection to the base station also does not need to apply this minimum power and thus does not need to consume it. Accordingly, the monitoring device can be designed to monitor whether a data router at a respective location is consuming the minimum power required to maintain a connection to the nearest base station. If the data router no longer consumes this—preferably location-specific—minimum power or a power exceeding the minimum power, but a lower power, this is an indication that the data router has no connection to the base station. This in turn can be a criterion that causes the monitoring device to restart the data router.

A monitoring device according to the invention, which triggers a reset or a restart of a data router depending on its power or energy consumption, has the advantage that it is based solely on the power consumption of the data router or of a component or unit of the data router whose power consumption correlates with the transmission of data, and does not require any information about the data stream flowing or not flowing via the data router.

Thus, such a monitoring device does not require a data interface to the router. Rather, the monitoring device relies solely on the power supply to the data router. By not requiring a data connection to the data router, as other products require, no potential security vulnerability can arise.

Furthermore, due to the measurement principle, the invention is universally applicable, so that routers without WiFi or WLAN can also be monitored.

In a preferred embodiment, the monitoring device detects the power consumption of the data router at its power supply input, i.e., where the power required for its operation is supplied to the data router. Alternatively, however, the monitoring device can also be designed to detect the power consumption at a component or a unit of the data router whose power consumption correlates with the regular operation of the data router. Such a unit or component is, for example, the modem of the data router, in particular a mobile radio modem with a corresponding mobile radio transmitter and receiver. In particular, the current or power consumption of the processor unit of the data modem or of the data router, of the transceiver module of the data modem or of the radio module of the data modem can be detected.

The monitoring device can be configured in such a way that the monitoring criteria and the criteria for restarting or resetting the data router are adjustable, so that they can be adapted to the respective current conditions, for example. Monitoring criteria and the criteria for restarting or resetting the data router can be values—in particular limit values—for monitored or recorded parameters such as the power currently being consumed or the energy consumed within an assigned time period (corresponding to the average power consumed during this time period).

It is particularly preferred if the monitoring device can be “trained” or “taught” to automatically learn the given conditions in each case.

For example, the monitoring device can be designed to determine, in a learning phase, a value for a minimum amount of energy that the data router consumes within a predetermined period of time and to derive from this value a limit value for the amount of energy, below which a reset or a restart of the data router is triggered.

The monitoring device may also be provided with a neural network trained with training data sets representing the course of the power consumption of the data router over time for the case that the data router is operational and an Internet connection to the next node exists. The neural network can be designed as a binary classifier, which assigns data records representing the current power consumption of the data router either to the state class for which the neural network is trained (e.g. for the case that a data connection to the Internet exists)—or not to this state class. If a current data set cannot be assigned to the state class representing a functional data router, the neural network outputs a correspondingly low membership value, which in turn can be the criterion for restarting the data router.

A neural network of a monitoring device configured as a binary classifier can also be trained with training data sets that represent the course of the power consumption of the data router in the event that the data router is not operational or there is no data connection. In this case, the monitoring device is designed to trigger a reset or a restart of the data router if the neural network—e.g. the binary classifier—assigns a data set representing a current power consumption to the state class for which the neural network is trained. Thus, a high membership value to the state class “data router not ok” can be used as a criterion for restarting or resetting the data router.

A monitoring device with a neural network offers the advantage that the test criterion that leads to the triggering of a restart or reset of the data router is not a simple threshold value or limit value comparison, but represents a pattern of the power consumption of the data router. This allows the monitoring device to be tuned more precisely to site-specific characteristics of the data router and its power consumption.

The data sets—and thus also the training data sets—are preferably data tuples representing the course of the power consumption of the data router over a predetermined period of time, preferably a few minutes. Accordingly, the monitoring device is preferably designed to record the power consumption of the data router over the corresponding period of time and preferably to sample (scan) and digitize power values. The power recording is preferably carried out in a sliding window.

The monitoring device preferably has a microcontroller-controlled electronic circuit as a sensing unit. This is designed to continuously sense the current consumption of any downstream data router. Preferably, the current consumption is analyzed and evaluated by an evaluation unit. The evaluation unit may contain the neural network as mentioned before.

Alternatively, the sensing unit can also be designed to sense the power consumption of a component or unit of the data router whose power consumption correlates with the transmission of data. Preferably, this is a data modem of the data router. In particular, the current or power consumption of the processor unit of the data modem or of the data router, of the transceiver module of the data modem or of the radio module of the data modem can be sensed.

The evaluation unit of the monitoring device is connected to the sensing unit and is designed to analyze the output signal of the sensing unit with respect to at least one test criterion and to trigger a reset or a restart of the data router if the test criterion is met. For this purpose, the evaluation unit may comprise the aforementioned neural network, wherein the output signal supplied by the sensing unit comprising data records that represent the respective current time profile of the power consumption of the data router.

If the evaluation by the evaluation unit shows that the case of “crash”/“freeze” has occurred with the device, the power supply of the router is preferably briefly interrupted and restored. This leads to a forced reset of the router or at least a part of the router, e.g. the part of the router that is responsible for an external data connection.

A method according to the invention for monitoring a data router comprises the steps:
Sensing at least one measured value correlated with the power consumption of a data router,
Checking the measured value against a reference criterion;
Restart or reset the router depending on the test result.

For example, the measured value correlated with the power consumption of a data router may be the current consumed by the router.

Checking the measured value against a reference criterion can be, for example, a comparison with a reference value. The reference value can be, for example, the minimum energy or the minimum amount of current (electrical charge) that the router consumes in the operational state within a predetermined period of time, preferably a few minutes. However, the reference criterion can also be formed by a neural network trained with corresponding training data sets, in particular a neural network in the form of a binary classifier.

Restarting the router can be accomplished by momentarily interrupting the power to the router or by delivering a reset signal to the data router via an appropriate control line.

Another aspect is the use of a system comprising a data router and a monitoring device connected thereto or integrated therein and/or a monitoring device of the type described herein in a data processing device of a monitoring device of a renewable energy generation plant or in a charging station for electric vehicle or the like. Renewable energy generation plants, such as wind energy plants or photovoltaic plants, typically have data processing devices that monitor, for example, the feeding of generated energy into the power grid. Renewable energy plants are often located in remote locations, so they rely on a reliable connection to the Internet. Automated restarting of a frozen data router using the monitoring device presented here is therefore very helpful. The same applies to charging columns for electric vehicles. In the case of charging columns, there is the additional factor that a data router that has been frozen for a longer period of time renders the charging column unusable for the corresponding period of time, since electricity that has been refueled during this period cannot be billed. The invention will now be explained in more detail by means of embodiment examples with reference to the figures. From the figures:

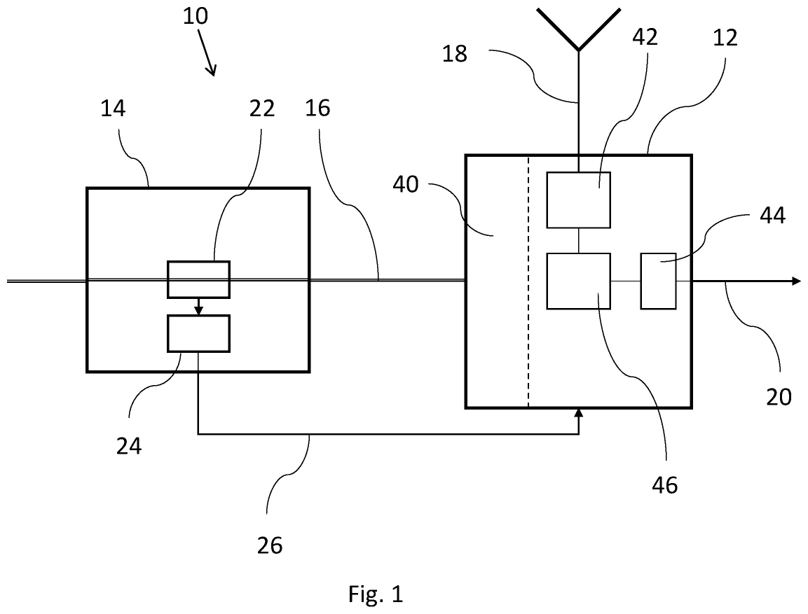

FIG. 1: shows a first variant of a system according to the invention with a data router with integrated power supply and a monitoring device in a simplified, schematic block diagram;

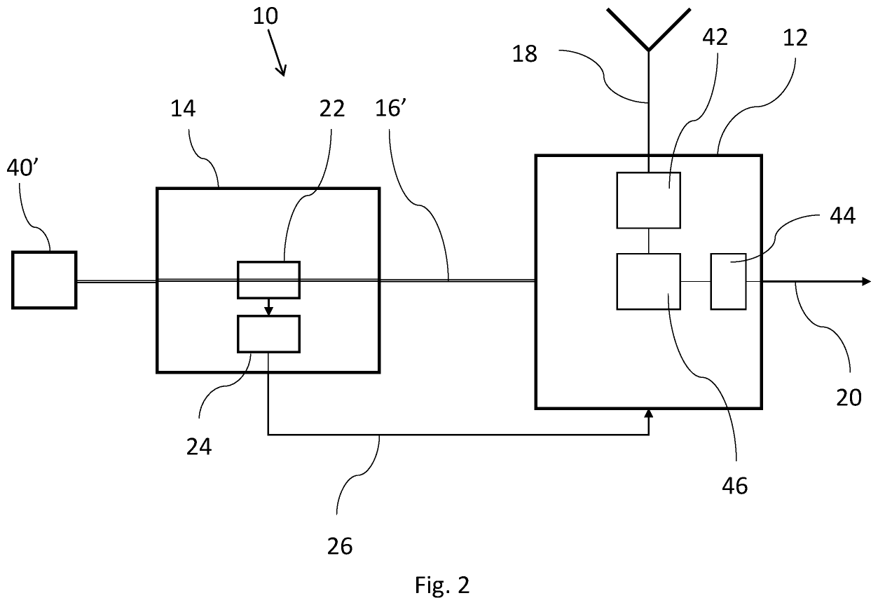

FIG. 2: shows a first variant of a system according to the invention with a data router with external power supply and a monitoring device in a simplified, schematic block diagram;

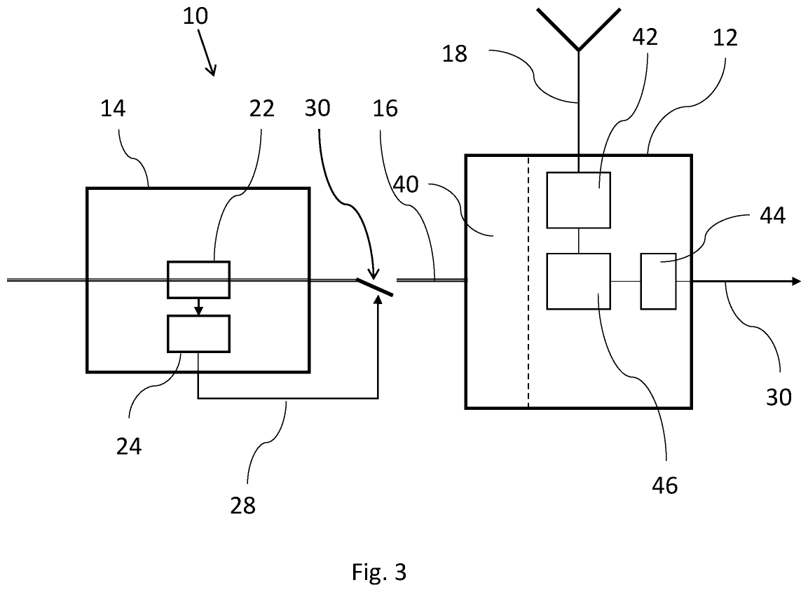

FIG. 3: shows a second variant of a system according to the invention with a data router and a monitoring device in a simplified, schematic block diagram;

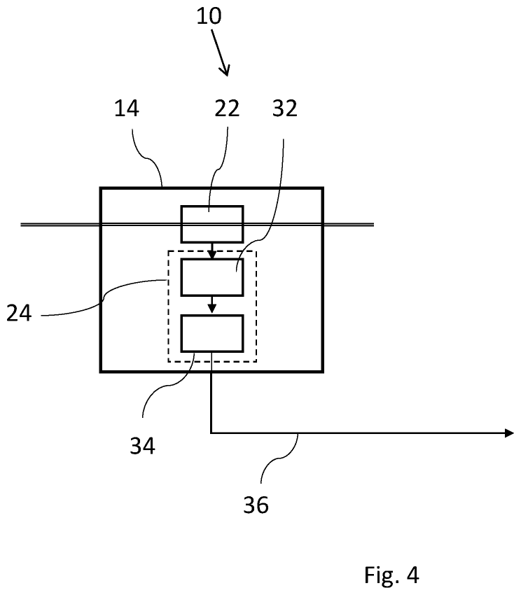

FIG. 4: shows a more detailed illustration of a neural network monitoring device according to the invention; and

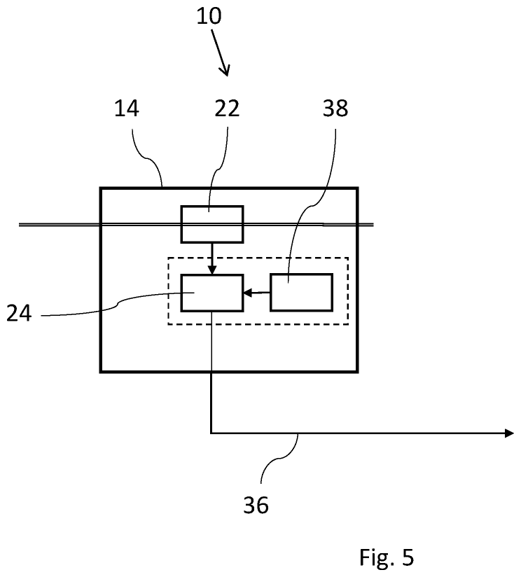

FIG. 5: shows a more detailed illustration of a monitoring device according to the invention with a parameter memory for an evaluation unit

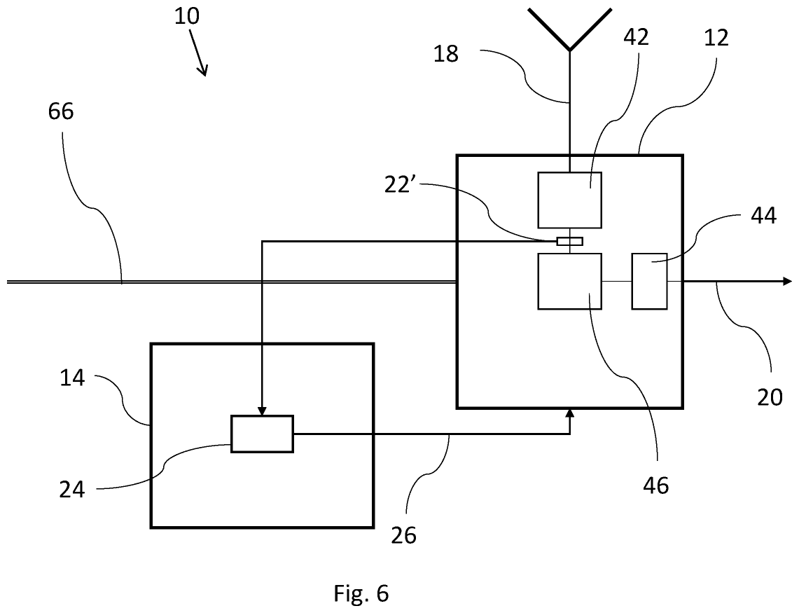

FIG. 6: shows a third variant of a system according to the invention with a data router and a monitoring device in a simplified, schematic block diagram;

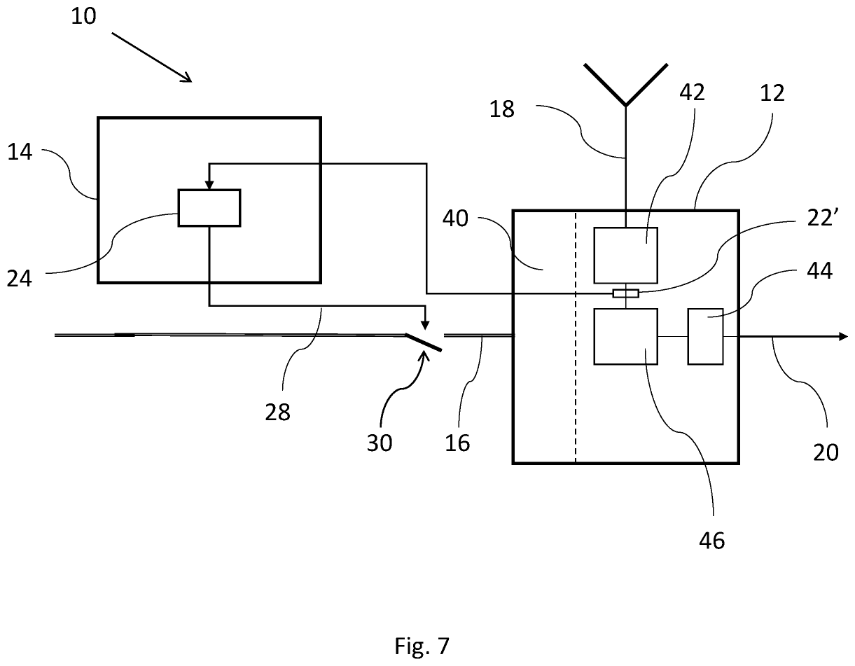

FIG. 7: shows a fourth variant of a system according to the invention with a data router and a monitoring device in a simplified, schematic block diagram; and

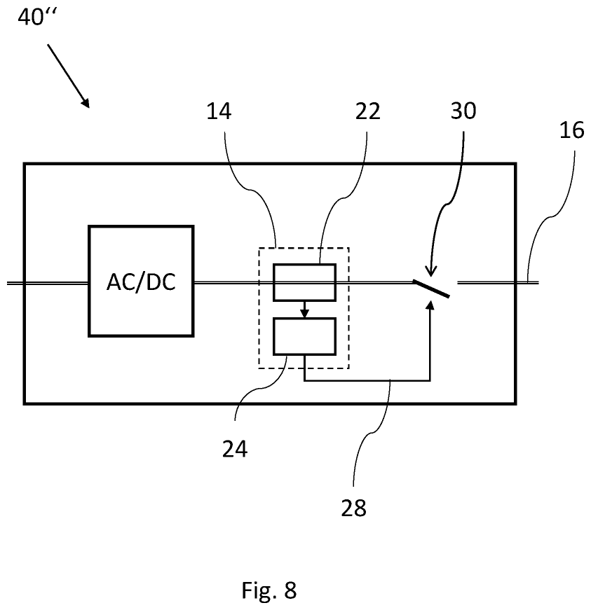

FIG. 8: shows an external power supply unit which is designed to continuously measure the power output and to cause a brief interruption of the power output by the power supply unit when the test criterion is met.

A system 10 according to the invention has a data router 12 and a monitoring device 14.

The data router 12 has a power supply line 16 via which the data router 12—in particular its power supply unit 40—is supplied with the electrical power required for operation of the data router 12. The power supply unit 40 may be integrated in the data router 12. However, the power supply unit 40′ can also be a separate power supply unit which is connected to the power supply input of the data router 12 by means of a cable as a DC power supply line 16′; see FIG. 2 The data router 12 can, for example, be a mobile radio router with a mobile radio modem 42 and have an antenna 18 in order to be able to receive or transmit data packets wirelessly. Data processing devices can be connected to the data router 12 and in particular its processor unit 46 via corresponding wireless or wired interfaces 44, which are to be connected to the Internet, for example. By way of example, a corresponding data line 20 is shown in FIGS. 1 and 2. However, the data processing devices connected to the data router 12 may also be connected to the data router 12 wirelessly, for example via wireless LAN (WiFi).

In regular operation, the data router 12 repeatedly makes contact with a base station, for example. A minimum electrical power is required for this. In the event of a malfunction of the data router 12, it may “freeze” and then no longer be able to establish a data connection to a base station. As a result, the power consumption of the data router 12 is consistently very low, and does not have the characteristic minimum power peaks that occur in the case of an active data connection between the data router 12 and a base station.

In order to be able to detect a possible malfunction of the data router 12, the monitoring device 14 is provided. This comprises a sensing unit 22, which may be implemented for example in the form of a preferably microcontroller-controlled electronic circuit and which is configured to sense the current or power consumption of the data router 12 via the power supply line 16 and to provide measured values representing the current or power consumption. If the power supply for the data router 12 is a separate power supply connected by a cable to a power supply input of the data router 12, the cable 16 typically carries the DC voltage required to operate the data router. Also in this case, the sensing unit 22 is adapted to sense the current or power consumption of the data router 12 via the power supply cable 16.

The sensing unit 22 is connected to an evaluation unit 24, which is designed to evaluate the measured values formed by the sensing unit 22 and, in particular, to check them with respect to a test criterion. The test criterion is selected to represent a characteristic power consumption of the data router 12 in its regular operation or—alternatively—a characteristic power consumption of the data router 12 when it has “crashed” or “frozen”.

The evaluation unit 24 is configured to cause a reset or restart of the data router 12 if the test based on the test criterion indicates that the data router 12 does not exhibit power consumption characteristic of regular operation, but in particular exhibits lower power consumption.

A test criterion can be the value of the power consumption over a specified period of time—preferably a sliding time window. De facto, the test criterion in this case is thus the electrical energy consumed by the data router within the specified time period.

Alternatively or additionally, the test criterion can also be the fluctuation of the power or current consumed by the data router 12. It is characteristic for a “frozen” data router 12 if its power consumption—and thus also its current consumption—remains constant or almost constant over a longer period of time and does not exhibit any major fluctuations. The “freezing” of the data router can thus be recognized by the fact that its current consumption does not exhibit such fluctuations as are associated with regular contact with a base station.

Preferably, the test criterion is derived from a typical pattern of power consumption. For this purpose, the evaluation unit 24 may comprise a neural network 32 (see FIG. 4) which is designed as a binary classifier and which is trained with training data sets formed by data tuples representing the power consumption of a respective data router 12 over a predetermined period of time—preferably the temporal course of the power or current consumption of the respective data router 12 over a predetermined period of time. In this regard, the training data sets may represent the power or current consumption of the data router 12 for periods of time when the router is functioning properly or, alternatively, for periods of time when the data router 12 is not functioning properly. Preferably, the training data sets are determined individually for a particular data router 12, as the power or current consumption of a data router 12 may depend on its particular circumstances and also on the type of data router 12 and data processing devices connected thereto.

If the evaluation of the measured values by the evaluation unit 24 shows that the data router 12 is no longer functioning properly, the evaluation unit 24 either triggers a reset of the data router 12 via a reset line 26 (see FIGS. 1 and 2) or it causes a switch 30 to be opened via a control line 28 in order to interrupt the power supply to the data router 12 and in this way force a restart of the data router 12 (see FIG. 3).

If the evaluation unit 24 has a neural network 32 designed as a binary classifier (see FIG. 4), the neural network can assign current data records formed by the sensing unit 22 from recorded measured values to the state “data router ok” or “data router not ok”, for example. As soon as the neural network has assigned one or a predetermined number of successive data records formed by the sensing unit 22 to the state “data router not ok”, a signal generator 34 connected to the neural network 32 can generate a control signal and output it via a signal line 36, which causes a reset or restart of the data router 12. Signal line 36 thus corresponds, for example, to reset line 26 of FIG. 1 or 2 or control line 28 of FIG. 3.

In this case, the sensing unit 22 is designed to sense measured values and to form data records from these, which represent the respective current power consumption of the data router 12. These data records are fed to the neural network 32 of the evaluation unit 14, which is designed as a binary classifier, and classified by the neural network determining a membership value for the respective current data record to a state class for which the neural network has been trained by means of training data records. The training data sets could for example represent the state “data route OK” and thus a state class and thus define a state class that corresponds to an operational data router. The neural network determines a membership value to this state class for each current data set and provided this membership value at a node of the output layer of the neural network. If the membership value for the state class “data router OK” falls below a predefined minimum value—which thus defines a test criterion—the signal generator 34 connected downstream of the neural network 32 can generate the control signal and output it via a signal line 36, which causes a reset or restart of the data router 12.

FIG. 5 shows a monitoring device 14 in which the evaluation unit 24 is connected to a parameter memory 38. The parameter memory 38 can, for example, contain individual parameter values for a respective system 10, e.g. for the power consumption of the data router 12 in the idle state or the like, so that the evaluation unit 24 can trigger a reset or restart of the data router 12, e.g. depending on location-specific criteria for the power consumption.

In alternative embodiments, it is provided that a sensing unit 22′ senses the current or power consumption of a unit or component of the data router 12, in particular the current or power consumption of the cellular modem 42. This is because the inventors have recognized that the power or current consumption of the cellular modem 42 also correlates with the operating state of the data router 12 and decreases accordingly when the data router 12 is “crashed” or “frozen”.

Except for the design of the sensing unit 22′, the embodiment variant shown in FIG. 6 corresponds approximately to the embodiment variant shown in FIG. 1 or 2. Similarly, the embodiment shown in FIG. 7 corresponds to the embodiment shown in FIG. 3, except for the design of the sensing unit 22′.

With respect to the respective configuration of the evaluation unit 24, it should be noted that the configuration of the evaluation unit 24 in the embodiments shown in FIGS. 6 and 7 is adapted in each case to the correspondingly configured sensing unit 22′ in such a way that the test criteria applied by the evaluation unit 24 correspond to the output signals supplied by the sensing unit 22′ during operation. If the evaluation unit 24 includes, for example, a neural network 32, the training data sets with which the latter has been trained are generated with a corresponding sensing unit 22′.

If the evaluation unit 24 contains a parameter memory 38 (see FIG. 5), then the parameter values stored in the parameter memory 38 are matched to the power or current values that the sensing unit 22′ senses during operation or in the idle state of the data router 12.

In the case of a data router 12′ with an external power supply unit 40′, the sensing unit 22 can also be integrated into the external power supply unit. In terms of the embodiment example in FIG. 3, the external power supply may also include the monitoring device with the sensing unit 22 and the evaluation unit 24 and be designed to briefly interrupt the power supply to the data router if the data router does not draw a predetermined minimum amount of power within a predetermined period of time or the evaluation unit has otherwise determined that the data router is not functioning as intended. In this case, the data router itself may remain unchanged from conventional data routers with an external power supply.

An external (or also integrated) power supply unit with a sensing unit, which is designed to continuously sense the power output and to provide an output signal correlated with the power output, and with an evaluation unit, which is connected to the sensing unit and is designed to analyze the output signal of the sensing unit with regard to at least one test criterion and, if the test criterion is met, to cause a brief interruption of the power output by the power supply unit, thus represents an independently protectable idea. In contrast to other power supply units, such an external power supply unit is designed to interrupt the power output only for a short time, e.g. for a few seconds up to a few minutes, e.g. for 20 seconds up to a maximum of 120 seconds, in order to cause a restart of an electronic device connected to the power supply unit during operation. A corresponding power supply unit 40″ is shown schematically in FIG. 8.
10 System
12 Data router
14 Monitoring device
16 Power supply line
18 Antenna
20 Data line
22, 22′ Sensing unit
24 Evaluation unit
26 Reset line
28 Control line
30 Switch
32 Neural network
34 Signal generator
36 Signal line (control line or reset line)
38 Parameter memory
40 Power supply
42 Mobile modem
44 Cable interface
46 Processor unit

What is claimed is:

1. A system comprising a data router and a monitoring device connected to or integrated with the data router, the monitoring device configured to monitor a power consumption of the data router or a component or unit of the data router whose power consumption correlates with the transmission of data and to trigger a restart or reset of the data router depending on its power consumption.

2. The system according to claim 1, wherein the data router comprises electronic components, in particular a mobile radio modem and a wired interface for connecting further data processing devices via a data line, as well as a power supply unit for supplying the electrical components of the data router with power.

3. The system according to claim 1, wherein the monitoring device is adapted to monitor whether the data router or a component or unit of the data router whose power consumption correlates with the transmission of data consumes a predetermined minimum power within a predetermined period of time, and to trigger a restart or a reset of the data router if the power consumed by the data router in the predetermined period of time is less than the predetermined minimum power.

4. The system according to claim 3, wherein the value for the predetermined minimum energy is represented by a variable stored in a parameter memory of the monitoring device.

5. The system according to claim 1, wherein the monitoring device comprises a sensing unit in the form of an electronic circuit which is designed to continuously sense the power consumption of the downstream data router or of a component or unit of the data router, power consumption of the downstream data router or of a component or unit of the data router whose power consumption correlates with the transmission of data, and to provide an output signal correlated with the power consumption of the data router or of a component or unit of the data router whose power consumption correlates with the transmission of data.

6. The system according to at least claim 5, wherein the monitoring device has an evaluation unit which is connected to the sensing unit and is designed to analyze the output signal of the sensing unit with regard to at least one test criterion and to trigger a reset or a restart of the data router if the test criterion is met.

7. The system according to at least claim 6, wherein the evaluation unit has a neural network and the output signal supplied by the sensing unit comprises data records which represent the respective current temporal course of the power consumption of the data router or of a component or unit of the data router whose power consumption correlates with the transmission of data.

8. A monitoring device for a system, wherein;
the system comprises a data router and a monitoring device connected to or integrated with the data router, the monitoring device configured to monitor a power consumption of the data router or a component or unit of the data router whose power consumption correlates with the transmission of data and to trigger a restart or reset of the data router deepening on its power consumption, and
the monitoring device is characterized by a sensing unit in the form of an electronic circuit which is designed to continuously sense the power consumption of the downstream data router or of a component or unit of the data router whose power consumption correlates with the transmission of data and to provide an output signal correlated with the power consumption of the data router or of the component or unit of the data router, the power consumption of which correlates with the transmission of data, the monitoring device also having an evaluation unit which is connected to the sensing unit and is designed to analyze the output signal of the sensing unit with regard to at least one test criterion and to trigger a reset or a restart of the data router if the test criterion is fulfilled.

9. The method device according to claim 8, wherein the evaluation unit comprises a neural network configured as a binary classifier.

10. Use, in a data processing device of a monitoring device of a renewable energy generation plant or in a charging station for electric vehicle or the like, of one or more of.
a system comprising a data router and a monitoring device connected to or integrated with the data router, the monitoring device configured to monitor a power consumption of the data router or a component or unit of the data router whose power consumption correlates with the transmission of data and to trigger a restart or reset of the data router depending on its power consumption; and
a monitoring device characterized by a sensing unit in the form of an electronic circuit which is designed to continuously sense the power consumption of the downstream data router or of a component or unit of the data router whose power consumption correlates with the transmission of data and to provide an output signal correlated with the power consumption of the data router or of the component or unit of the data router, the power consumption of which correlates with the transmission of data, the monitoring device also having an evaluation unit which is connected to the sensing unit and is designed to analyze the output signal of the sensing unit with regard to at least one test criterion and to trigger a reset or a restart of the data router if the test criterion if fulfilled.

11. A method for monitoring a data router, the method comprising:
sensing at least one measured value correlated with the power consumption of a data router or a component or unit of the data router whose power consumption correlates with the transmission of data,
checking the measured value against a reference criterion; and
restarting or resetting the router depending on the test result.

12. The method according to claim 11, wherein the at least one measured value correlated with power consumption of a data router or the component or unit of the data router whose power consumption correlates with the transmission of data is the amperage of current drawn by the router or the component or unit of the data router.

13. The method according to claim 11, wherein checking the measured value against a reference criterion includes comparing the measured value to a reference value.

14. The method according to claim 13, wherein the reference value is the minimum energy or the minimum amount of current that the data router or the component or unit of the data router whose power consumption correlates with the transmission of data consumes in the operable state within a predetermined period of time, preferably a few minutes.

15. The method according to claim 11, wherein the reference criterion is a membership value formed by a neural network trained with appropriate training data sets in the form of a binary classifier to a state class of the data router or the component or unit of the data router whose power consumption correlates with the transmission of data.

16. The method according to claim 10, wherein restarting the data router is effected by momentarily interrupting the power supply to the data router, or wherein restarting the data router is effected by delivering a reset signal to the data router.

17. A power supply comprising:
a sensing unit adapted to continuously sense the power delivered and to provide an output signal correlated with the power delivered, and
an evaluation unit which is connected to the sensing unit and is designed to analyze the output signal of the sensing unit with regard to at least one test criterion,
wherein the power supply is configured to cause a momentary interruption of power output by the power supply for a period of time between 5 seconds and 120 seconds when the test criterion is met.
